(19) United States
(12) Patent Application Publication
(10) Pub. No.: US 2004/0092282 A1
(43) Pub. Date: May 13, 2004

(54) Remote control system of electronic appliances and remote control method employing the same

(75) Inventors: Kyoung-Won Kim, Yongin city (KR); Houn-Soo Kim, Yongin city (KR); Sang-Jin Lee, Suwon city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/700,479

(22) Filed: Nov. 5, 2003

(30) Foreign Application Priority Data
Nov. 6, 2002 (KR) 2002-68484

(51) Int. Cl. H04B 7/00; H04Q 7/20; G08C 15/06; G08B 23/00

(52) U.S. Cl. 455/522; 340/870.02

(57) ABSTRACT

The present invention provides a remote control system and a remote control method of an electronic appliance, capable of controlling an electronic appliance remotely by means of a user's terminal accessible to the Internet, without constructing a separate network.

### CROSS-REFERENCE TO RELATED APPLICATIONS

This application claims the benefit of Korean Patent Application No. 2002-68484, filed Nov. 6, 2002, in the Korean Intellectual Property Office, the disclosure of which is incorporated herein by reference.

### BACKGROUND OF THE INVENTION

1. Field of the Invention

The present invention relates to a remote control system of electronic appliances and a remote control method employing the same, and, more particularly, a remote control system of electronic appliances capable of controlling power supply to the electronic appliances and a remote control method employing the same.

2. Description of the Related Art

These days, a variety of technologies remotely controlling several electronic appliances positioned in separate locations have been developed. For example, there has been introduced a technology remotely controlling power supply to electronic appliances in separate locations.

Conventionally, as a method of controlling power supply to an electronic appliance in a remote manner, a method of waking up a personal computer remotely with the use of ring signals has been disclosed. Where the computer controlled remotely is connected to a telephone network through a modem, power to the computer is reactivated by ring signals sensed by a ring sensor of the modem if a user makes a call to the computer by means of a telephone set. This method is advantageous in that no construction of a separate network is necessary since it is available for using an existing installed telephone network; however, there is a limitation that only the telephone set is available as a user's terminal for remote control.

In addition, there has been introduced a method of remotely controlling power of an electronic appliance through the Internet. This method has been applied to an electronic appliance linked to a LAN (Local Area Network), particularly an electronic appliance connected via an Ethernet connection, wherein power to the electronic appliance can be controlled remotely by providing a Magic Packet having a specific bit-stream to the electronic appliance to be controlled from the user's terminal. The user's terminal used in this method is not limited to a telephone set, i.e., any terminal is available as long as it can access the Internet. However, a separate LAN is needed when a remote control system is employed at home, and thus, there is an extra expense to construct the system.

### SUMMARY OF THE INVENTION

Accordingly, it is an aspect of the present invention to provide a remote control system of electronic appliances capable of remote control of the electronic appliances by means of a user's terminal available for accessing the Internet, without constructing a separate network, and a remote control method employing the same.

Additional aspects and/or advantages of the present invention will be set forth in part in the description that follows and, in part, will be obvious form the description, or may be learned by practicing the present invention.

The foregoing and/or other aspects of the present invention are achieved by providing a remote control system of controlling an electronic appliance through the Internet, comprising: an electronic appliance, comprising: a telephone network accessing unit, which can be accessed with a proper telephone number of the electronic appliance; a power supplying unit; and a controller controlling the power supplying unit so that the electronic appliance is supplied with driving power according to a telephone signal received through the telephone network accessing unit; and a remote control server, comprising: a telephone number database to store the proper telephone number of the electronic appliance, a telephone signal transmitting unit to transmit the telephone signal to the electronic appliance; and a server controlling unit to read out the proper telephone number of the electronic appliance from the telephone number database according to a selection of power control of the electronic appliance by a user making an access thereto through the Internet, to control the telephone signal transmitting unit, and to supply the telephone signal to the telephone network accessing unit of the selected electronic appliance having the read proper telephone number through the telephone network so that power of the selected electronic appliance is turned on.

According to an aspect of the present invention, the telephone signal comprises a ring signal or a DTMF (dual-tone multi-frequency) signal.

According to an aspect of the present invention, the remote control server further comprises a user information database storing therein information on the user of the electronic appliance, and wherein the server controlling unit requests the user to enter proper information on the user when the user accesses the server controlling unit via the Internet, compares the proper user information entered by the user with the stored user information in the user information database to determine whether the proper user information and the stored user information are identical, and allows access of the user when the proper user information and the stored user information are identical.

According to an aspect of the present invention, the electronic appliance further comprises an Internet accessing unit allowing access to the remote control server through the Internet, and wherein the controller transmits a result of control of the electronic appliance to the remote control server through the Internet accessing unit.

According to another aspect of the present invention, the foregoing and/or other aspects may be also achieved by providing a remote control method of controlling an electronic appliance through the Internet, comprising: storing a proper telephone number of the electronic appliance in a remote control server; allowing a user to access the remote control server through the Internet; and controlling the electronic appliance to enable its power by reading out the stored proper telephone number of a selected electronic appliance according to a selection of power control of the electronic appliance by the user accessing the remote control server and by supplying a telephone signal to the selected electronic appliance having the proper telephone number through a telephone network.

According to an aspect of the present invention, the telephone signal comprises a ring signal or a DTMF signal.

According to an aspect of the present invention, the remote control method further comprises storing information on the user of the electronic appliance; requesting the user to enter a proper user information when the user accesses the remote control server via the Internet; determining whether the proper user information is identical to the stored user information when the proper user information has been entered; and allowing access by the user when the proper user information and the stored user information are identical.

According to an aspect of the present invention, the remote control method comprises allowing the user accessing the remote control server to ascertain a result of control of the electronic appliance transmitted to the remote control server via the Internet.

### BRIEF DESCRIPTION OF THE DRAWINGS

These and/or other aspects and advantages of the present invention will become apparent and more readily appreciated from the following description of the embodiments, taken in conjunction with the accompany drawings of which:

FIG. 1 is a schematic diagram showing a configuration of a remote control system of electronic appliances according to an embodiment of the present invention;

FIG. 2 is a control block diagram of the remote control system of electronic appliances shown in FIG. 1;

FIG. 3 is a flow chart showing control of the remote control system of electronic appliances according to an embodiment of the present invention; and

FIG. 4 is a flow chart showing control of the remote control system of electronic appliances according to another embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

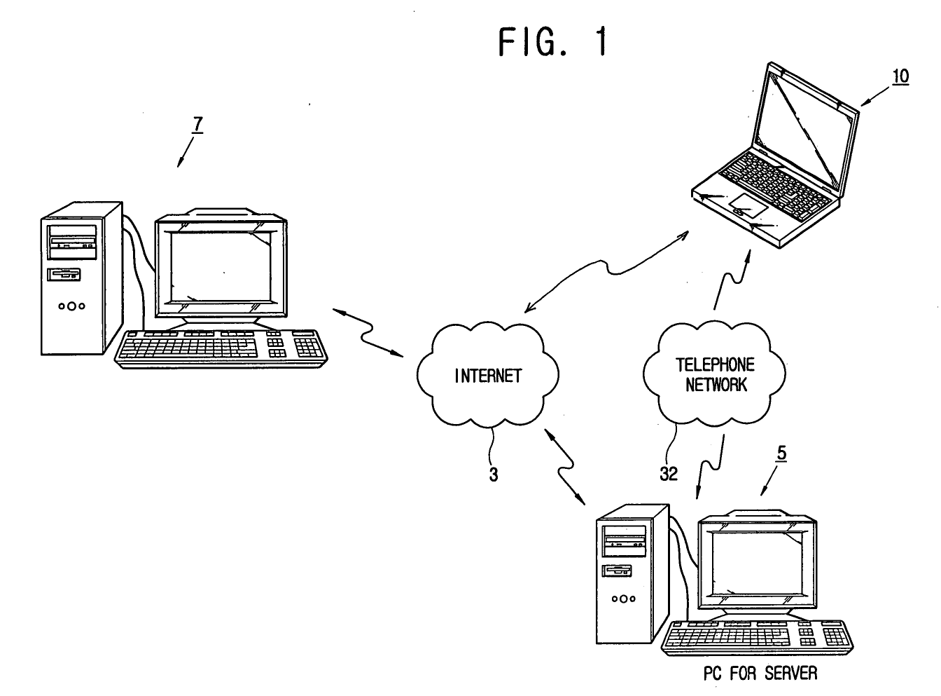

FIG. 1 is a schematic diagram showing a configuration of a remote control system of electronic appliances according to the present invention. As shown therein, the remote control system of electronic appliances according to the present invention comprises a remote control server 5, a user's terminal 7 available for accessing the remote control server 5 through the Internet 3, and an electronic appliance 10 whose power is controlled through the user's terminal 7.

A user can control power of the electronic appliance 10 remotely through the Internet 3 with the use of the user's terminal 7, which accesses the Internet 3. In an embodiment, the user's terminal 7 is a desktop computer, a notebook computer, a PDA (Personal Data Assistant), etc. If the user accesses the remote control server 5 through the Internet 3, the remote control server 5 provides a web page that is stored in advance, into which proper user information can be entered, to be displayed on the display window of the user's terminal 7. In an embodiment, the proper user information includes an ID and a password defined in advance. If the user enters the proper user information and is allowed to access the remote control server 5, a list of a plurality of electronic appliances 10 that are connected to the remote control server 5 through a telephone network 32 is displayed on the web page of the user's terminal 7.

If the user chooses one of the plurality of electronic appliances 10 to control from the list of the plurality of electronic appliances 10 that is displayed on the user's terminal 7, the power of the selected electronic appliance 10 is controlled by a telephone signal transmitted to the selected electronic appliance 10 through the telephone network 32 from the remote control server 5. That is, the power of an electronic appliance 10 can be controlled remotely by the user's terminal 7 available for accessing the Internet 3 with the use of the existing telephone network 32.

The electronic appliance 10 transmits information concerning proper telephone number, current status of power, result of control, etc. to the remote control server 5 through the Internet 3. According to this, the user accessing the remote control server 5 is able to ascertain the information through the user's terminal 7.

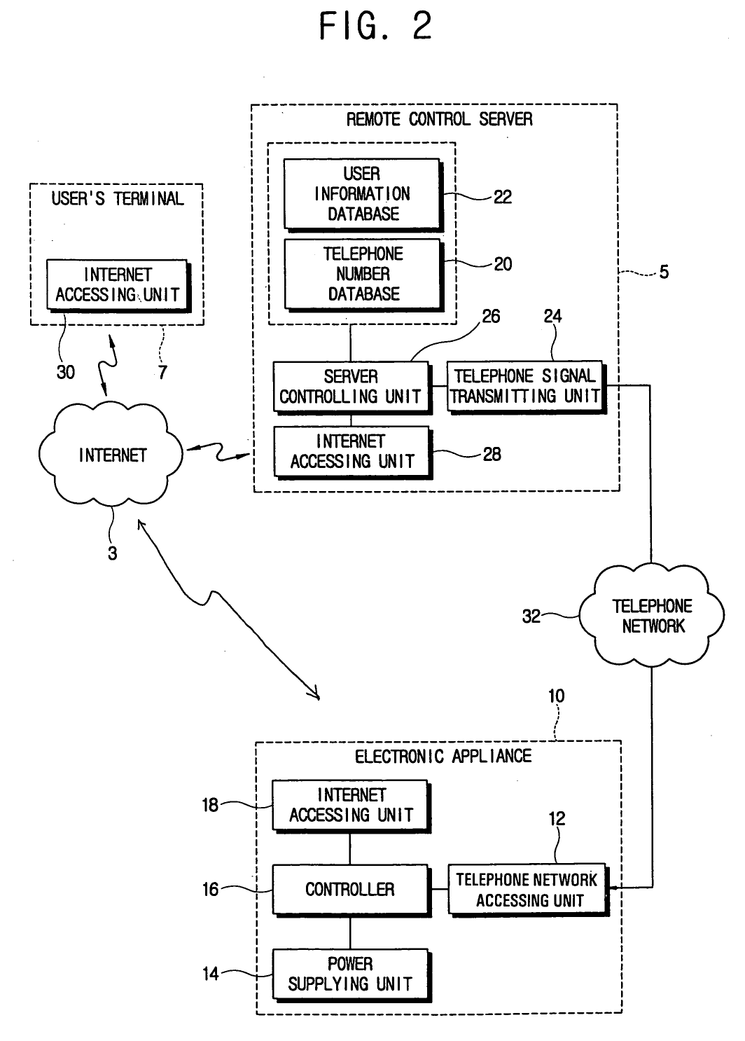

FIG. 2 shows in details control blocks of the remote control system of the electronic appliance shown in FIG. 1. As shown therein, the remote control server 5 is comprised of a telephone number database 20 storing therein proper telephone numbers assigned to the selected electronic appliance 10 to be controlled, a user information database 22 storing therein user information, an Internet accessing unit 28 for accessing the Internet 3, a telephone signal transmitting unit 24 for transmitting a telephone signal to the selected electronic appliance 10 if power control of the selected electronic appliance 10 is indicated by the user through the user's terminal 7, and a server controlling unit 26 controlling the telephone signal transmitting unit 24 so as to transmit the telephone signal to the selected electronic appliance 10 by retrieving and reading out the telephone number database 20, as power control of the selected electronic appliance 10 has been indicated by the user accessed thereto via the Internet 3.

The telephone number database 20 stores therein proper telephone numbers assigned to respective electronic appliances 10. When the electronic appliance 10 remotely controlled by the user's terminal 7 is connected to the remote control server 5 through the Internet 3, the server controlling unit 26 acquires the proper telephone numbers to be stored, which were assigned to respective electronic appliances 10. These telephone numbers are provided in order to transmit a telephone signal to a selected electronic appliance 10, when a list of each electronic appliance 10 connected to the remote control server 5 through the telephone network 32 is displayed on the user's terminal 7. Here, the list may be displayed as a symbol of the electronic appliance 10. Otherwise, the name of the electronic appliance 10 or the proper telephone number assigned thereto may be displayed.

The user information database 22 stores therein proper user information, for example, an ID and a password as defined in advance. By this, if the user accesses the remote control server 5 through the Internet 3 and enters an ID and a password, the server controlling unit 26 compares the data in the user information database 22 with the ID and the password as entered by the user.

Data of the user's terminal 7 and the electronic appliance 10 is transmitted and received through the Internet accessing unit 28. The user information is inputted from the user's terminal 7 available for accessing the Internet 3 through the Internet accessing unit 28. Such information as the proper telephone number, current status of power and IP address of the electronic appliance 10, and the time when the power is controlled and the like is transmitted from the electronic appliance 10 accessible to the Internet 3 through the Internet accessing unit 28.

The telephone signal transmitting unit 24 transmits the telephone signal to the electronic appliance 10 as power control of the electronic appliance 10 is selected. Herein, the telephone signal comprises a ring signal or a DTMF (dual-tone multi-frequency) signal.

The ring signal is generated when the user selects the electronic appliance 10, the power of which he desires to control, among the list of electronic appliances 10 displayed on the web page of the user's terminal 7. That is, the ring signal is transmitted to the selected electronic appliance 10, and a telephone network accessing unit 12 of the selected electronic appliance 10 (to be described later) senses the ring signal. In the case where the selected electronic appliance 10 is turned off, power is supplied to the electronic appliance 10 by the sensed ring signal.

In the case of a DTMF signal as another embodiment, if the electronic appliance 10, the power of which the user desires to control, is selected through the user's terminal 7, the telephone signal transmitting unit 24 transmits the ring signal to the electronic appliance 10. Subsequently, the electronic appliance 10 receives the telephone signal from the user. If the user presses buttons on the keypad of the user's terminal 7, or number buttons on a cellular phone, to control power of the electronic appliance 10, the telephone signal transmitting unit 24 transmits this information to the electronic appliance 10 as a DTMF signal.

The DTMF is generally a signal generated when buttons on a telephone set are pressed and transmitted to a telephone office. In the telephone set employing the DTMF, each key on the telephone set pressed by the user produces two tones respectively having a specific frequency. According to the buttons of the telephone set, the DTMF comprises a tone belonging to a high frequency and a tone belonging to a low frequency. Employing this principle, power of the concerned electronic appliance 10 can be controlled in a remote manner by transmitting the DTMF signal generated by manipulation of the user's terminal 7 to the electronic appliance 10. For example, the electronic appliance 10 can be set so as for the power thereof to be turned on when the button numbered 1 is selected.

The server controlling unit 26 requests the user to input the proper user information, for example, an ID and a password, where the user accesses the remote control server 5 through the Internet 3. This is available by allowing the web page stored in advance in the remote control server 5, into which the proper information is entered, to be displayed on the display window of the user's terminal 7. According to this, if the user inputs an ID and a password, the server controlling unit 26 compares them with the user information stored in the user information database 22 and determines whether they are identical. If it is determined that they are identical, the user is allowed to access the remote controlling server 5, thereby allowing only an authorized user to control the concerned electronic appliance 10 in a remote manner.

The server controlling unit 26 displays a list of electronic appliances 10 connected to the remote control server 5 through the telephone network 32 on the web page of the user's terminal 7.

The server controlling unit 26 reads out the proper telephone number of an electronic appliance 10 from the telephone number database 20 if the user selects the electronic appliance 10 to control the power thereof, from the list of electronic appliances displayed on the web page of the user's terminal 7. Also, the server controlling unit 26 controls the telephone signal transmitting unit 24 so as to supply the telephone signal to the telephone network accessing unit 12 of the electronic appliance 10 through the telephone network 32. Herein, the telephone signal is comprised of a ring signal or a DTMF signal.

The user's terminal 7 includes an Internet accessing unit 30, through which it accesses the Internet 3, thereby receiving and transmitting the data from and to the remote control server 5. In embodiments, access to the Internet 3 is available through wired or wireless connections using super high speed network connecting unit such as an ADSL modem, a wireless LAN card, a Bluetooth module, etc. The user's terminal 7 transmits the user information to the remote control server 5 through the Internet accessing unit 30 and receives the information of the electronic appliance 10 to be controlled, stored in the remote control server 5, from the remote control server 5.

The electronic appliance 10 controlled through the user's terminal 7 accessible to the Internet 3 comprises a telephone network accessing unit 12, a power supplying unit 14, and a controller 16 controlling the power supplying unit 14 according to the telephone signal received through the telephone network accessing unit 12. The electronic appliance 10 further includes an Internet accessing unit 18, through which data communication with the remote control server 5 is available.

The telephone network accessing unit 12 comprises a wire modem or a CDMA module, etc., receiving a ring signal or a DTMF signal from the telephone signal transmitting unit 24 of the remote control server 5. The telephone network accessing unit 12 is in the condition of standby at all time, thereby being able to receive continuously the ring signal or the DTMF signal as a signal requesting the power control from the user's terminal 7, while power of the electronic appliance 10 is off.

The controller 16 controls the power supplying unit 14 so as to allow the electronic appliance 10 to be supplied with power, by the ring signal sensed through the telephone network accessing unit 12.

In an embodiment, the controller 16 controls the power supplying unit 14 so as to allow power of the electronic appliance 10 to be controlled according to a selection of the electronic appliance 10 through the user's terminal 7 and a separate manipulation for power control, for example, according to the DTMF signal generated by pressing a specific button on the keypad.

The controller 16 transmits information concerning the electronic appliance 10, for example, time when its power has been controlled or the current status of its power, or IP information of the electronic appliance 10, etc., to the remote control server 5 through the Internet accessing unit 18.

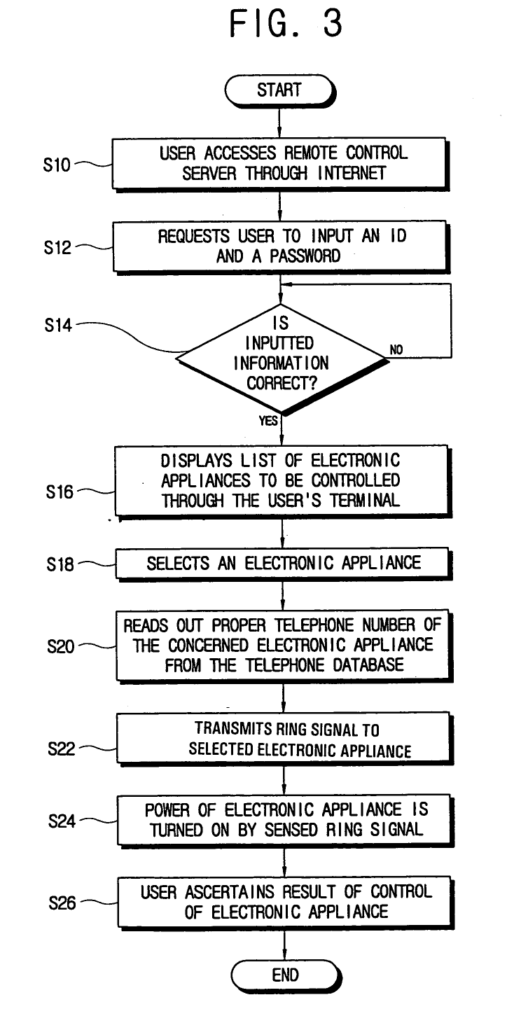

A flow chart showing control by the remote control system of the electronic appliance 10 with this configuration has been shown in FIG. 3. Referring to this figure, a user first accesses the remote control server 5 through the Internet 3 (S10). The remote control server 5 requests that the user enter an ID and a password for authentication, when the access is made (S12). If the user enters an ID and a password, the server controlling unit 26 determines whether the inputted ID and the inputted password are identical to the ID and the password stored therein beforehand (S14). If it is determined that the inputted ID and the inputted password are identical to the ID and the password stored beforehand, then the user is allowed to control the electronic appliance 10, and a list of the electronic appliances 10 is displayed on the display window of the user's terminal 7 (S16). At this time, the list of the electronic appliances 10 may be displayed in the form of a symbol indicating the electronic appliance 10, or with the name and the proper telephone number thereof. If the user selects an electronic appliance 10, the power of which he desires to control (S18), the server controlling unit 26 retrieves the telephone number database 20 and reads out the proper telephone number of the selected electronic appliance 10 (S20). The server controlling unit 26 controls the telephone signal transmitting unit 24 so as to transmit the telephone signal to the electronic appliance 10 having the proper telephone number. Then, a ring signal is supplied to the telephone network transmitting unit 12 of the electronic appliance 10 through the telephone network 32 (S22). The telephone network accessing unit 12 senses the ring signal and the controller 16 controls the power supplying unit 14 to supply power to the electronic appliance 10 according to the sensed ring signal. Accordingly, power of the electronic appliance 10 is turned on (S24). The server controlling unit 26 receives the result of control from the electronic appliance 10 accessing the Internet 3, and the user accessing the remote control server 5 is able to ascertain the result of control of the concerned electronic appliance 10 through the user's terminal 7 (S26). Herein, the result of control indicates the time when the electronic appliance 10 has been supplied with power, the current status of power, etc.

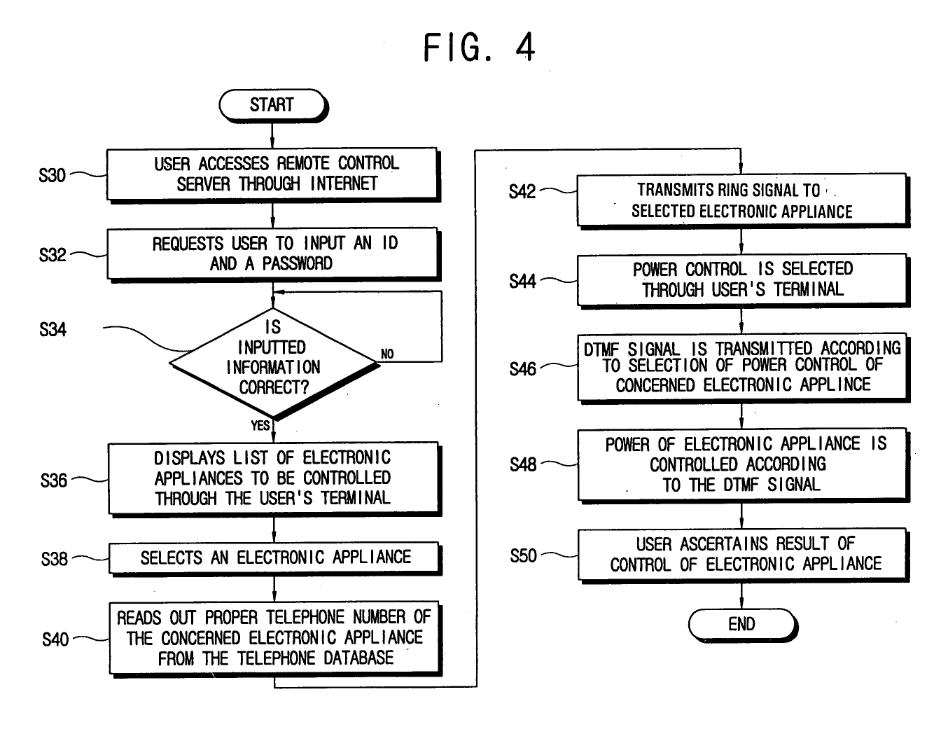

A flow chart showing control of the electronic appliance according to another embodiment has been shown in FIG. 4. Description on the control following the same flow as in FIG. 3 will be omitted. If a user transmits a telephone signal to the remote control server 5 after accessing the remote control server 5, the telephone network accessing unit 12 of the electronic appliance 10 senses a ring signal and receives the telephone signal (S30 through S42). The user may select power control through a keypad and the like on the user's terminal 7 (S44). For example, the electronic appliance 10 may be set up that power is turned on when the number button for 1 on a cellular phone is pressed. However, the present invention is not limited to the number button for 1. In other embodiments, different number buttons may be used. At this time, the telephone signal transmitting unit 24 transmits a DTMF signal to the telephone network accessing unit 12 of the electronic appliance 10 in response to the pressing of the number button on the cellular phone (S46). The controller 16 of the electronic appliance 10 controls the power supplying unit 14 so as to supply power thereto, according to the DTMF signal transmitted (S48). The server controlling unit 26 receives a result of control from the electronic appliance 10 accessed to the Internet 3, and the user making an access to the remote control server 5 ascertains the result of control of the selected electronic appliance 10 through the user's terminal 7 (S50).

Because the user can use the existing telephone network 32 already installed, there is no need of constructing a separate network, and accordingly, it is possible to control power of an electronic appliance 10 remotely by means of a user's terminal available for accessing the Internet 3.

In addition, the user can ascertain the result of control of the electronic appliance 10 through the user's terminal available for accessing the Internet 3.

Meanwhile, the electronic appliance 10 employed in the above-described embodiments is preferably comprised of a computer-related apparatuses such as a desktop computer, a notebook computer, a PDA, etc., or a set-top box.

In the above-described embodiments, power of the electronic appliance 10 linked to the remote control server 5 through the telephone network 32 is activated by manipulation by the user of the user's terminal 7 that is accessible to the Internet 3. Where power of the electronic appliance 10 is turned on, the electronic appliance 10 may be constructed so that its power is turned off according to a ring signal or a DTMF signal.

As described above, the present invention allows the electronic appliance 10 to be controlled remotely by the user's terminal 7 accessible to the Internet 3 without constructing a separate network, by comprising a remote control server 5 having a server controlling unit 26 which reads out the proper telephone number of the electronic appliance 10 from the telephone number database 20 according to a selection of power control of the electronic appliance 10 by the user making an access thereto through the Internet 3, controlling the telephone signal transmitting unit 24 and supplying the telephone signal to the telephone network accessing unit 12 of the concerned electronic appliance 10 through the telephone network 32 so that power of the electronic appliance 10 is turned on.

According to the present invention, there have been provided a remote control system and a remote control method of an electronic appliance, capable of controlling the electronic appliance remotely by means of the user's terminal accessible to the Internet, without constructing a separate network.

The hardware included in the system may include memories, processors, and/or Application Specific Integrated Circuits (“ASICs”). Such memory may include a machine-readable medium on which is stored a set of instructions (i.e., software) embodying any one, or all, of the methodologies described herein. Software can reside, completely or at least partially, within this memory and/or within the processor and/or ASICs. For the purposes of this specification, the term “machine-readable medium” shall be taken to include any mechanism that provides (i.e., stores and/or transmits) information in a form readable by a machine (e.g., a computer). For example, a machine-readable medium includes read only memory (“ROM”), random access memory (“RAM”), magnetic disk storage media, optical storage media, flash memory devices, electrical, optical, acoustical, or other form of propagated signals (e.g., carrier waves, infrared signals, digital signals, etc.), etc.

Although a few embodiments of the present invention have been shown and described, it will be appreciated by those skilled in the art that changes may be made in these embodiments without departing from the principles and spirit of the present invention, the scope of which is defined in the appended claims and their equivalents.

What is claimed is:

1. A remote control system of controlling an electronic appliance through the Internet, comprising:
an electronic appliance comprising:
a telephone network accessing unit, which is accessible with a proper telephone number of the electronic appliance,
a power supplying unit, and
a controller controlling the power supplying unit so that the electronic appliance is supplied with driving power according to a telephone signal received through the telephone network accessing unit; and
a remote control server comprising:
a telephone number database to store the proper telephone number of the electronic appliance,
a telephone signal transmitting unit to transmit the telephone signal to the electronic appliance, and
a server controlling unit to read out the proper telephone number of the electronic appliance from the telephone number database according to a selection of power control of the electronic appliance by a user making an access thereto through the Internet, to control the telephone signal transmitting unit, and to supply the telephone signal to the telephone network accessing unit of the selected electronic appliance having the read proper telephone number through the telephone network so that power of the selected electronic appliance is enabled.

2. The remote control system according to claim 1, wherein the telephone signal comprises a ring signal or a DTMF (dual-tone multi-frequency) signal.

3. The remote control system according to claim 1,
wherein the remote control server further comprises a user information database storing therein information on the user of the electronic appliance, and
wherein the server controlling unit requests the user to enter proper information on the user when the user accesses the server controlling unit via the Internet, compares the proper user information entered by the user with the stored user information in the user information database to determine whether the proper user information and the stored user information are identical, and allows access of the user when the proper user information and the stored user information are identical.

4. The remote control system according to claim 1,
wherein the electronic appliance further comprises an Internet accessing unit allowing access to the remote control server through the Internet, and
wherein the controller transmits a result of control of the electronic appliance to the remote control server through the Internet accessing unit.

5. A remote control method of controlling an electronic appliance through the Internet, comprising:
storing a proper telephone number of the electronic appliance in a remote control server;
allowing a user to access the remote control server through the Internet; and
controlling the electronic appliance to enable a power thereof by reading out the stored proper telephone number of the electronic appliance that is selected according to a selection of power control of the electronic appliance by the user accessing the remote control server and by supplying a telephone signal to the selected electronic appliance having the proper telephone number through a telephone network.

6. The remote control method according to claim 5, wherein the telephone signal comprises a ring signal or a DTMF (dual-tone multi-frequency) signal.

7. The remote control method according to claim 5, further comprising:
storing information on the user of the electronic appliance;
requesting the user to enter a proper user information when the user accesses the remote control server via the Internet;
determining whether the proper user information is identical to the stored user information when the proper user information has been entered; and
allowing access by the user when the proper user information and the stored user information are identical.

8. The remote control method according to claim 5, further comprising:
allowing the user accessing the remote control server to ascertain a result of control of the electronic appliance transmitted to the remote control server via the Internet.

9. A system to remotely control electronic appliances, comprising:
a user terminal;
a remote control server that is connected to the user terminal via the Internet; and
a plurality of electronic appliances that are connected to the remote control server via a telephone network,
wherein a user controls power to the plurality of electronic appliances via the user terminal.

10. The system of claim 9, wherein the user selects one of the plurality of electronic appliances to control using the user terminal, wherein the selected electronic appliance transmits appliance information to the remote control server via the Internet, and wherein the remote control server transmits the appliance information to the user terminal.

11. The system of claim 10, wherein the appliance information comprises a telephone number, a current power status, an IP (internet protocol) address, a time of control, and a result of control.

12. The system of claim 9, wherein the remote control server comprises:
a user information database to store user information, wherein the user information comprises a stored ID (identifier) and a stored password;
a telephone number database to store a plurality of assigned telephone numbers that correspond to the plurality of electronic appliances;
a telephone signal transmitting unit to transmit a telephone signal to the plurality of electronic appliances;
an internet accessing unit to access the Internet; and
a server controlling unit to retrieve one of the plurality of assigned telephone numbers corresponding to one of the plurality of electronic devices from the telephone number database and to control the telephone signal transmitting unit, to compare the user information with an inputted ID and an inputted password.

13. The system of claim 12, wherein the user terminal displays the plurality of electronic appliances to the user as a list by name, as a plurality of symbols, or as a list by assigned telephone number.

14. The system of claim 12, wherein each of the plurality of electronic devices comprises:
a telephone network accessing unit to receive the telephone signal and to cause power to be supplied to the electronic device;
a power supplying unit to supply power to the electronic device;
a controller to control the power supplying unit based upon the telephone signal; and
an internet accessing unit to transmit appliance information to the remote control server.

15. The system of claim 14, wherein the telephone signal is a ring signal, and wherein power is supplied to the electronic device when a ring signal is detected.

16. The system of claim 14, wherein the telephone signal is a DTMF (dual-tone multi-frequency) signal, and wherein power is supplied to the electronic device when a signal is detected that corresponds to a predetermined button on a telephone.

17. The system of claim 12, wherein the server controlling unit allows the user to control the plurality of electronic devices when the user information is equivalent to the inputted ID and inputted password.

18. The system of claim 12, wherein the telephone network accessing unit is always in a standby mode, while power to the electronic device is deactivated.

19. A remote control server that is connected to a user terminal via an Internet and to a plurality of electronic appliances via a telephone network, comprising:
a user information database to store user information, wherein the user information comprises a stored ID (identifier) and a stored password;
a telephone number database to store a plurality of assigned telephone numbers that correspond to the plurality of electronic appliances;
a telephone signal transmitting unit to transmit a telephone signal to the plurality of electronic appliances;
an internet accessing unit to access the Internet; and
a server controlling unit to retrieve one of the plurality of assigned telephone numbers corresponding to one of the plurality of electronic devices from the telephone number database and to control the telephone signal transmitting unit, to compare the user information with an inputted ID and an inputted password,
wherein a user controls power to the plurality of electronic appliances via the user terminal.
